(19) United States
(12) Patent Application Publication
(10) Pub. No.: US 2006/0114078 A1
(43) Pub. Date: Jun. 1, 2006

(54) Electronic volume

(76) Inventor: Yoshitsugu Sugimoto, Kamifukuoka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/286,385

(22) Filed: Nov. 25, 2005

(30) Foreign Application Priority Data
Nov. 26, 2004 (JP) 2004-342956

(51) Int. Cl. H01P 1/22

(52) U.S. Cl. 333/81 R

(57) ABSTRACT

To reduce errors due to the on-resistance of the switches. The electronic volume includes a first attenuator 2 whose input is connected to a signal input terminal 1, first switch S1 connected between an output of the first attenuator 2 and input of a output buffer 8, second switch S2 connected to a second attenuator 3 and between an output of the second attenuator 3 and an input of the output buffer 8, and a switching unit 7 connected to three attenuators 4, 5, 6 connected in series to the signal input terminal 1 and between respective outputs of the attenuators 4, 5, 6 and the second attenuator 3. The switch 7 includes a series circuit including a resistor whose one end is connected to the output of the attenuators 4, 5, 6 and the other end is connected to the input of the second attenuator 3 and three switches in series (R1 and S3, R2 and S4, R3 and S5) and a series circuit including a resistor connected in series between the other end of the three switches in series and ground (R4 and S6). Resistors R1 to R4 have the same resistance and switches S1 to S6 have the same on-resistance.

### BACKGROUND OF THE INVENTION

The present invention relates to an electronic volume that can achieve highly accurate attenuation by canceling error components due to an on-resistance of a switch.

Examples of a conventional electronic volume include a circuit of a weighting system having a configuration shown in FIG. 6. Referring to FIG. 6, the circuit includes a signal input terminal 1, resistors R51 to R62, switches S51 to S62, a voltage-follower output buffer 8 and a signal output terminal 9.

In the electronic volume, by selecting and turning on any one of the switches S51 to S54, attenuation in the range of 0 to −3 dB by 1 dB step can be achieved with a group of the resistors R51 to R54. In addition, by selecting and turning on any one of the switches S55 to S62, attenuation in the range of −4 to −28 dB by 4 dB step can be achieved with a group of the resistors R55 to R62. Therefore, combinations of one turned-on switch among the switches S51 to S54 and one turned-on switch among the switches S55 to S62 can provide attenuation in the range of 0 to −31 dB by 1 dB step. Such a weighting-system electronic volume is disclosed in Japanese Unexamined Patent Publication No. 177371/1999, for example.

In the electronic volume of FIG. 6, however, although the resistors R51 to R62 have no effect on the circuit and thus cause no problem when attenuation of 0 dB is obtained by turning on the switches S51 and S55, other combinations of turned-on switches cause large errors due to the on-resistance of the switches. For example, when the switches S52 and S56 are turned on, the circuit becomes equivalent to the circuit of FIG. 7, in which the on-resistance R52 of the switch S52 has an influence on the resistance division ratio, resulting in attenuation different from the attenuation determined based on the resistors R51 to R62. Note that the on-resistance R56 of the switch S56 has no effect on the circuit since the input impedance of the output buffer 8 is large and therefore no current flows.

As described above, the electronic volume of FIG. 6 has a problem that the on-resistance of each of the switches S51 to S54 connected to the signal input terminal 1 leads to an offset of attenuation from the design value. For reducing the on-resistance of the switches S51 to S54, the size of MOS transistors constituting the switches needs to be increased, causing a problem that the size of the electronic volume is increased.

The present invention is intended to provide an electronic volume that solves the above-described problems by canceling the on-resistance of switches.

### SUMMARY OF THE INVENTION

According to a first aspect of the present invention, an electronic volume includes: N (N≧2) attenuators connected in series to a signal input terminal; a switching unit including N series circuits, each having one switch and one resistor connected to an output of one of the N attenuators, and one series circuit that has one switch and one resistor connected in series between outputs of the N series circuits and a ground; and an output buffer having an input connected to the outputs of the N series circuits of the switching unit. Each of the switches of the N series circuits has the same on-resistance as that of the switch of the one series circuit, and each of the resistors of the N series circuits has the same resistance as that of the resistor of the one series circuit.

According to a second aspect of the present invention, the electronic volume of the first aspect further includes: a first attenuator having an input connected to the signal input terminal; a first switch connected between an output of the first attenuator and the input of the output buffer; a second attenuator having an input connected to the outputs of the N series circuits of the switching unit; and a second switch connected between an output of the second attenuator and the input of the output buffer.

According to a third aspect of the present invention, in the electronic volume of the second aspect, the first attenuator is implemented by M (M≧2) resistors that are connected in series between the signal input terminal and a ground, and M switches each having one end connected to one of the M resistors and the other end commonly connected to the first switch. Furthermore, the second attenuator is implemented by M resistors that are connected in series between an output of the switching unit and a ground, and M switches each having one end connected to one of the M resistors and the other end commonly connected to the second switch.

According to the first and second aspects of the present invention, the on-resistance of switches affecting the resistance division ratio is canceled, leading to advantages that highly accurate attenuation can be achieved, and that the size of the whole electronic volume can be reduced since there is no need to increase the size of MOS transistors constituting the switches. In addition, according to the third aspect of the present invention, if the M switches of the first attenuator and the M switches of the second attenuator are implemented by transistors, one switch of the first attenuator and one switch of the second attenuator can be driven by a common driver. Therefore, the first and second attenuators can be driven by M drivers, allowing simplification of driving circuits.

### BRIEF EXPLANATION OF THE DRAWINGS

FIG. 1 is a basic block diagram of an electronic volume according to an Embodiment of the present invention;

FIG. 2 is a circuit diagram of a specific circuit of attenuators 4 to 7 of FIG. 1;

FIG. 3 is a circuit diagram of another example of a specific circuit of the attenuators 4 to 7 of FIG. 1;

FIG. 4 is a specific circuit diagram of an electronic volume;

FIG. 5 is a specific circuit diagram of another electronic volume;

FIG. 6 is a circuit diagram of a conventional electronic volume; and

FIG. 7 is a circuit diagram illustrating the operation of the circuit of FIG. 6.

### DETAILED DESCRIPTION

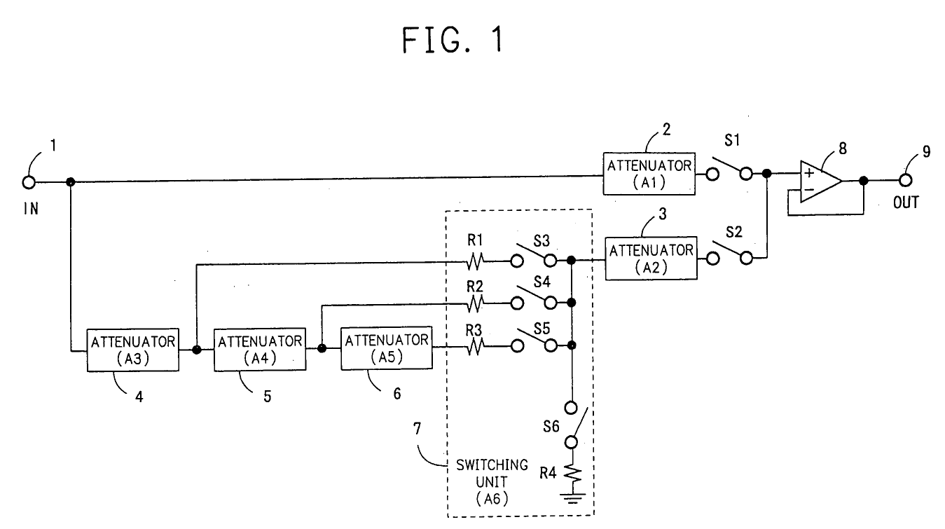

FIG. 1 is a block diagram for illustrating the principle of an electronic volume of an Embodiment of the present invention. Referring to FIG. 1, the electronic volume includes a signal input terminal 1, a first attenuator 2 (attenuation A1), a second attenuator 3 (attenuation A2), a third attenuator 4 (attenuation A3), a fourth attenuator 5 (attenuation A4), a fifth attenuator 6 (attenuation A5), a switching unit 7 (attenuation A6), a voltage-follower output buffer 8, and a signal output terminal 9. The electronic volume also includes switches S1 to S6. The switches S3 to S6 of the switching unit 7 have the same on-resistance. Resistors R1 to R4 of the switching unit 7 have the same resistance.

In the electronic volume, only when the switch S1 is turned on, attenuation A1 due to the attenuator 2 is achieved. At this time, a current does not flow through the switch S1 since the input impedance of the output buffer 8 is large. Thus, the on-resistance of the switch S1 has no effect on the circuit.

When the switches S1, S4 and S5 are turned off and the switches S2, S3 and S6 are turned on, total attenuation obtained by summing attenuation A2 due to the attenuator 3, attenuation A3 due to the attenuator 4, and attenuation A6 due to the resistors R1 and R4 of the switching unit 7 can be achieved. Since the resistors R1 and R4 have the same resistance and the switches S3 and S6 have the same on-resistance, the attenuation A6 is ½(=−6 dB). Therefore, the total attenuation in this case is represented as “A2+A3+A6”. The attenuation A6 is invariable from −6 dB regardless of the on-resistance values of the switches S3 and S6 (although the values need to be identical to each other). Since the impedance of the output buffer 8 is large, no current flows through the switch S2, and thus the on-resistance of the switch S2 has no effect on the circuit.

When the switches S1, S3 and S5 are turned off and the switches S2, S4 and S6 are turned on, total attenuation obtained by summing attenuation A2 due to the attenuator 3, attenuation A3 due to the attenuator 4, attenuation A4 due to the attenuator 5, and attenuation A6 due to the resistors R2 and R4 of the switching unit 7 can be achieved. Since the resistors R2 and R4 have the same resistance and the switches S4 and S6 have the same on-resistance, the attenuation A6 is ½(=−6 dB). Therefore, the total attenuation in this case is represented as “A2+A3+A4+A6”. The attenuation A6 is invariable from −6 dB regardless of the on-resistance values of the switches S4 and S6 (although the values need to be identical to each other).

When the switches S1, S3 and S4 are turned off and the switches S2, S5 and S6 are turned on, total attenuation obtained by summing attenuation A2 due to the attenuator 3, attenuation A3 due to the attenuator 4, attenuation A4 due to the attenuator 5, attenuation A5 due to the attenuator 6, and attenuation A6 due to the resistors R3 and R4 of the switching unit 7 can be achieved. Since the resistors R3 and R4 have the same resistance and the switches S5 and S6 have the same on-resistance, the attenuation A6 is ½(=−6 dB). Therefore, the total attenuation in this case is represented as “A2+A3+A4+A5+A6”. At this time, the attenuation A6 is invariable from −6 dB regardless of the on-resistance values of the switches S5 and S6 (although the values need to be identical to each other).

As described above, the on-resistance of the switches S3 to S6 is canceled, having no effect on the circuit. In addition, reducing the size of MOS transistors that constitute the switches is not required since there is no need to reduce the on-resistance.

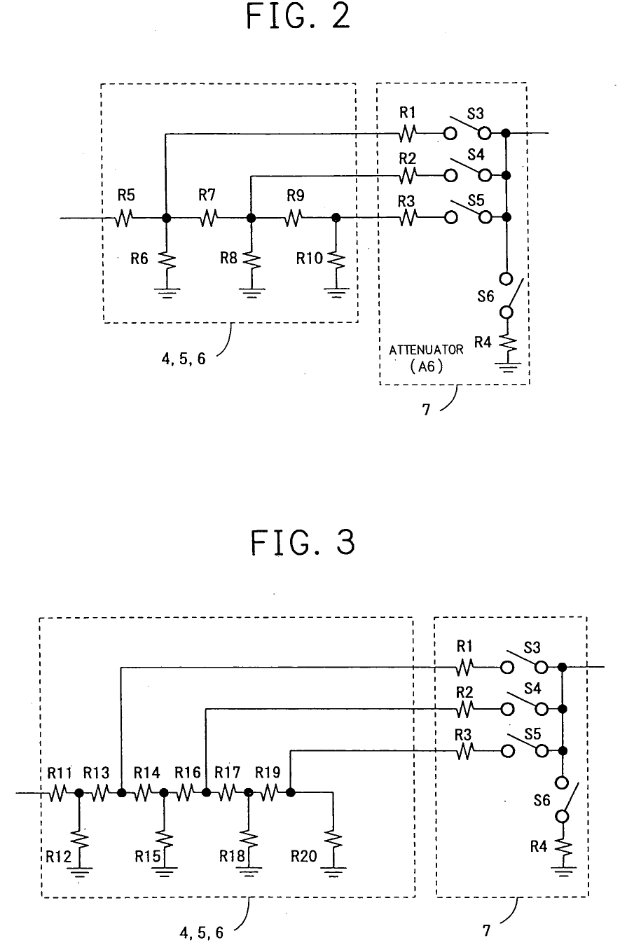

FIG. 2 is a circuit diagram specifically illustrating the attenuators 4 to 6 and the switching unit 7 of FIG. 1. The attenuators 4 to 6 are formed of resistors R5 to R 10. FIG. 3 is a circuit diagram of another example specifically illustrating the attenuators 4 to 6 and the switching unit 7. The attenuators 4 to 6 are formed of resistors R11 to R20. In the attenuators 4 to 6 of FIG. 3, by adequately setting the resistance values of the resistors R11 to R20, the input impedance can be kept almost constant no matter which of the switches S3 to S5 is turned on.

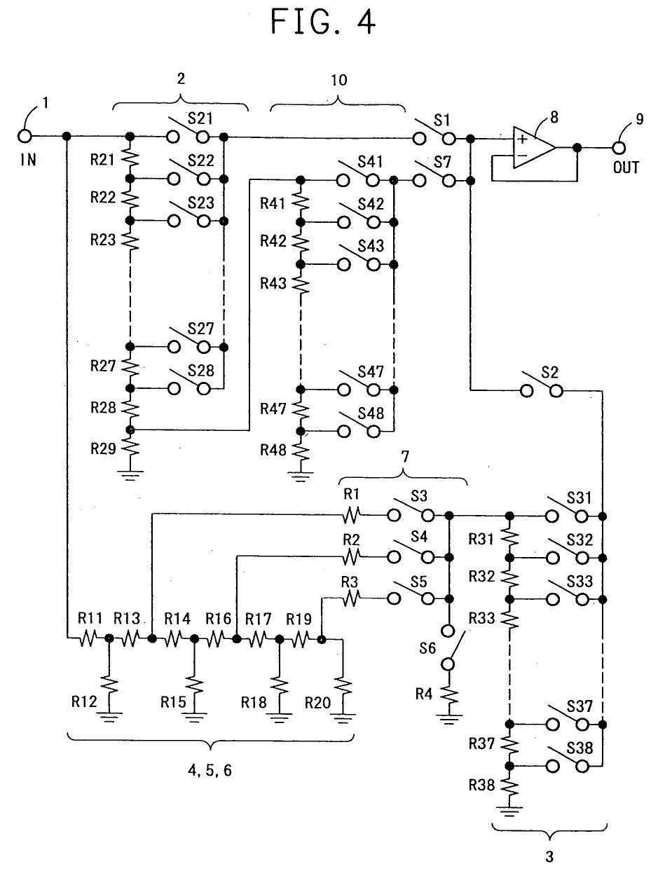

FIG. 4 is a circuit diagram showing the specific configuration of the whole electronic volume. The attenuator 2 includes resistors R21 to R29 and switches S21 to S28. Turning on only the switch S21 provides attenuation of 0 dB, turning on only the switch S22 provides −1 dB, turning on only the switch S23 provides −2 dB, and so forth, and thus turning on only the switch S28 provides −7 dB. Attenuation of −8 dB can be achieved through the bifurcation between the resistors R28 and R29.

The attenuator 3 includes resistors R31 to R38 and switches S31 to S38. Turning on only the switch S31 provides attenuation of 0 dB, turning on only the switch S32 provides −1 dB, turning on only the switch S33 provides −2 dB, and so forth, and thus turning on only the switch S38 provides −7 dB.

The attenuators 4 to 6 employ the configuration shown in FIG. 3. The attenuator 4 can provide attenuation of −10 dB, the attenuator 5 can provide attenuation of −8 dB, and the attenuator 6 can provide attenuation of −6 dB. The switching unit 7 can provide attenuation of −6 dB as described above by a combination of the switch S6 and any of the switches S3 to S5.

Another attenuator 10 including resistors R41 to R48 and switches S41 to S48 is newly added. Turning on only the switch S41 provides attenuation of 0 dB, turning on only the switch S42 provides −1 dB, turning on only the switch S43 provides −2 dB, and so forth, and thus turning on only the switch S48 provides −7 dB. A switch 7 is newly added.

In the electronic volume shown in FIG. 4, by only turning on the switch S1 and turning on any one of the switches S21 to S28, attenuation in the range of 0 dB to −7 dB by 1 dB step can be achieved.

In addition, by only turning on the switch S7 and turning on any one of the switches S41 to S48, attenuation in the range of −8 dB to −15 dB by 1 dB step can be achieved.

In addition, only when the switch S2 is turned on and the switches S31, S3 and S6 are turned on, −10 dB due to the attenuator 4 and −6 dB due to the resistors R1 and R4 are achieved, resulting in attenuation of −16 dB. At this time, by turning on any of the switches S32 to S38 instead of the switch S31, attenuation in the range of −17 dB to −23 dB by 1 dB step can be achieved.

Furthermore, only when the switch S2 is turned on and the switches S31, S4 and S6 are turned on, −10 dB due to the attenuator 4, −8 dB due to the attenuator 5, and −6 dB due to the resistors R2 and R4 are achieved, resulting in attenuation of −24 dB. At this time, by turning on any of the switches S32 to S38 instead of the switch S31, attenuation in the range of −25 dB to −32 dB by 1 dB step can be achieved.

In addition, only when the switch S2 is turned on and the switches S31, S5 and S6 are turned on, −10 dB due to the attenuator 4, −8 dB due to the attenuator 5, −6 dB due to the attenuator 6 and −6 dB due to the resistors R3 and R4 are achieved, resulting in attenuation of −30 dB. At this time, by turning on any of the switches S32 to S38 instead of the switch S31, attenuation in the range of −31 dB to −37 dB can be achieved.

That is, with the electronic volume of FIG. 4, attenuation in the range of 0 to −37 dB by 1 dB step can be achieved. At this time, the on-resistance of the switches S3 to S6 is canceled as described above. In addition, the switches S1, S2, S21 to S28, S31 to S38, S41 to S48 and S7 are connected in series to the input of the high-input impedance of the output buffer 8, and therefore no current flows through the switches. Thus, the on-resistance of the switches has no effect on the circuit.

Since only one of the switches S1, S2 and S7 is turned on, if the switches S21 to S28, S31 to S38 and S41 to S48 are implemented by transistors, the switches having reference numeral whose last digit is the same can be driven by a common driver. For example, driving the switches S21, S31 and S41 by the same driver causes no disadvantage. Therefore, the twenty-four switches S21 to S28, S31 to S38, and S41 to S48 can be driven by eight drivers, allowing simplification of the circuit configuration.

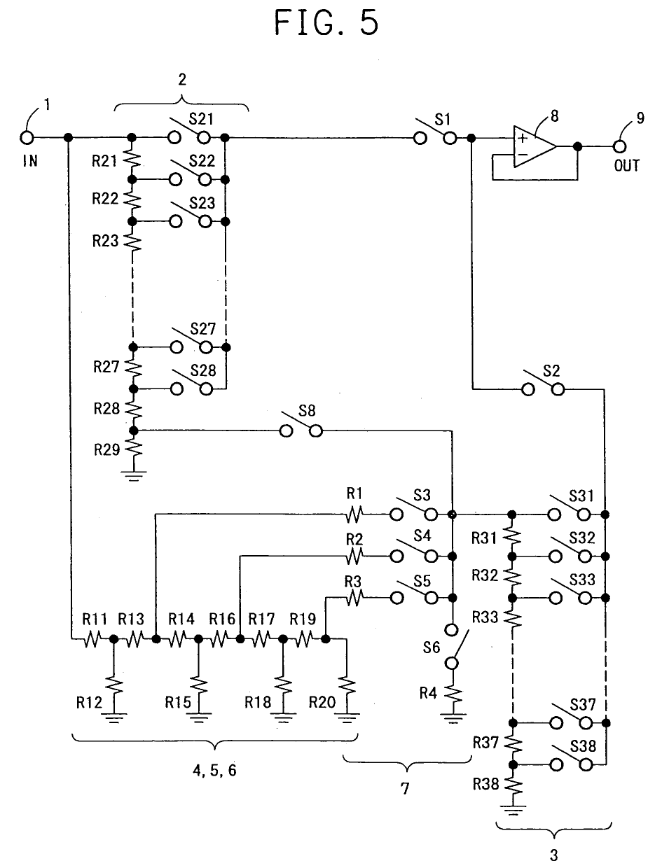

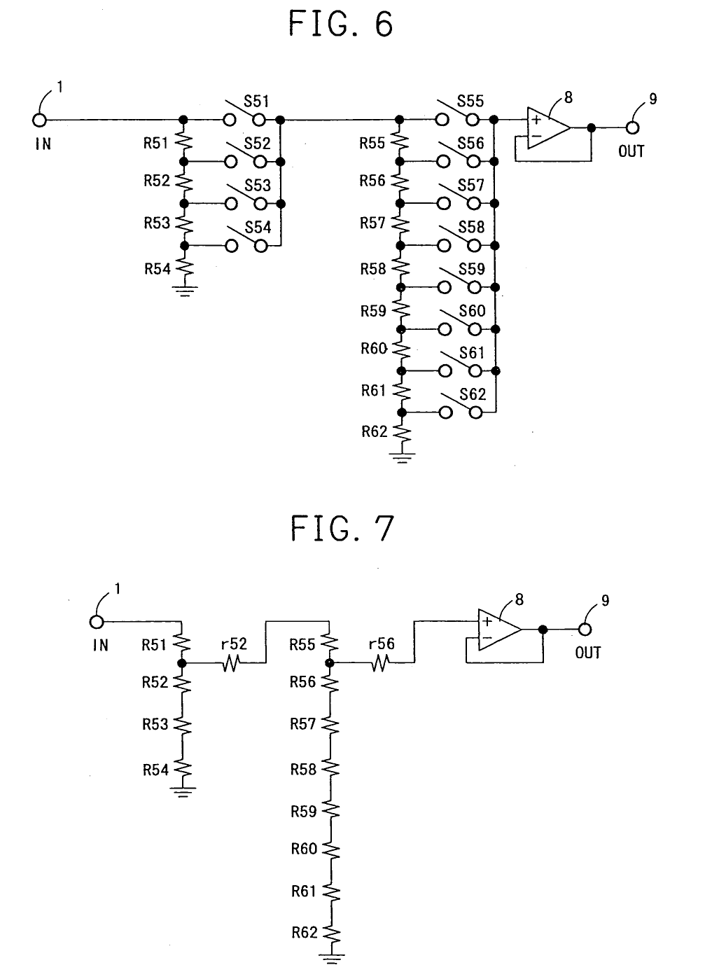

FIG. 5 is a circuit diagram showing the specific configuration of another example of an electronic volume. This electronic volume is different from the electronic volume of FIG. 4 in that the attenuator 10 and the switch S7 are omitted and another switch S8 is provided. In the electronic volume, by turning on only the switches S8 and S2 and turning on any of the switches S31 to S38, attenuation in the range of −8 dB to −15 dB by 1 dB step can be achieved similarly with the electronic volume of FIG. 4 achieving this attenuation with the switches S41 to S48. Other features are the same as those of the electronic volume of FIG. 4.

The electronic volume of FIG. 5 can achieve attenuation in the range of 0 to −38 dB by 1 dB step without using the attenuator 10 and the switch S7 of FIG. 4, providing an advantage that the circuit configuration can be simplified. Note that the on-resistance of the switch S8 needs to be reduced since the on-resistance of the switch S8 may have an effect on the circuit when attenuation is in the range of −8 dB to −15 dB.

What is claimed is:

1. An electronic volume, comprising:
N (N≧2) attenuators connected in series to a signal input terminal;
a switching unit including N series circuits, each having one switch and one resistor connected to an output of one of the N attenuators, and one series circuit that has one switch and one resistor connected in series between outputs of the N series circuits and a ground; and
an output buffer having an input connected to the outputs of the N series circuits of the switching unit,
wherein each of the switches of the N series circuits has the same on-resistance as that of the switch of the one series circuit, and each of the resistors of the N series circuits has the same resistance as that of the resistor of the one series circuit.

2. The electronic volume according to claim 1, further comprising:
a first attenuator having an input connected to the signal input terminal;
a first switch connected between an output of the first attenuator and the input of the output buffer;
a second attenuator having an input connected to the outputs of the N series circuits of the switching unit; and
a second switch connected between an output of the second attenuator and the input of the output buffer.

3. The electronic volume according to claim 2, wherein
the first attenuator is implemented by M (M≧2) resistors that are connected in series between the signal input terminal and the ground, and M switches, each having one end connected to one of the M resistors and the other end commonly connected to the first switch, and
the second attenuator is implemented by M resistors that are connected in series between an output of the switching unit and the ground, and M switches, each having one end connected to one of the M resistors and the other end commonly connected to the second switch.
